(19) United States
(12) Patent Application Publication
(10) Pub. No.: US 2017/0163185 A1
(43) Pub. Date: Jun. 8, 2017

(54) METHOD FOR SENSORLESS COMMUTATION OF A BRUSHLESS DIRECT CURRENT MOTOR

(71) Applicant: ZF Friedrichshafen AG, Friedrichshafen (DE)

(72) Inventors: Holger GOHMERT, Ravensburg (DE); Igor JANTZEN, Friedrichshafen (DE); Andreas FÜßL, Kressbronn am Bodensee (DE); Thomas HODRIUS, Weiler-Simmerberg (DE)

(73) Assignee: ZF Friedrichshafen AG, Friedrichshafen (DE)

(21) Appl. No.: 15/371,478

(22) Filed: Dec. 7, 2016

(30) Foreign Application Priority Data
Dec. 8, 2015 (DE) DE102015224560.8

(51) Int. Cl. H02P 6/182; H02P 27/08

(52) U.S. Cl. CPC H02P 6/182; H02P 27/08

(57) ABSTRACT

A method for sensorless commutation of a BLDC motor is presented, wherein the following steps are executed.In step 1, the voltage of a currentless phase is sampled in predetermined time intervals. In step 2, the voltage of the zero crossing, and the associated rotational rate, is determined on the basis of the time difference between two sampling points, and the point in time of the zero crossing is supplied to a commutation timer K, when a zero crossing has been detected between two sampling points. In step 3, the time until a predefined angular rotation of the motor is calculated on the basis of the determined rotational rate, and this time is transmitted to the commutation timer. In step 4, the commutation is initiated and the commutation time is reset when the time transmitted to the commutation time has elapsed.

### FIELD

The present invention relates to a method for sensorless commutation of a brushless direct current motor.

### BACKGROUND

Brushless direct current motors (“BLDC motor”) are used with increasing frequency in electrical drive technology. These motors are principally made of a rotor equipped with permanent magnets, a stationary stator that accommodates the coils, and a connecting part for the rotor and stator. With BLDC motors, the commutation of the motor electricity occurs via an electronic commutator, instead of a mechanical commutator. The electronic commutator can be referred to as a regulator, which, because of the possibility of making the commutation dependent on the position and rotational rate of the rotor, as well as the torque, can change, i.e. regulate, the frequency, and usually the amplitude, of the system as a function of the position and rotational rate of the rotor. By using electronic commutators, brushes susceptible to wear are no longer used, and the reliability of the overall system is increased. By eliminating the brushes, a smaller construction of the motor can also be implemented.

In order to ensure an efficient and fluid operation of the motor, the phases of the motor must be provided with power at precisely the right moment, making it necessary to determine the position of the rotors. For this, different methods can be used, wherein the most frequently used methods are the sensor controlled and sensorless commutation. With the sensor controlled commutation, Hall sensors are used for determining the position. With the sensorless regulation, or commutation, respectively, the rotor position is detected via the counter-voltage, which can also be referred to as counter EMF or back EMF, or inverse voltage, triggered in the coils of the stator, and evaluated by electronic control circuitry. This counter EMF opposes the natural movement of the motor, because a voltage is induced having the same polarity the operating voltage, and thus acting against the rotor current, due to the generator principle in the motor coils, even when the motor is in operation, when magnetic field lines cut through the motor coils. With BLDC motors, the counter EMF is normally trapezoidal.

A disadvantage of the sensor controlled commutation is that, as a result of the additional sensors needed, the costs and complexity of the overall system is increased. This is overcome by a sensorless regulation.

With sensorless commutation, the position of the rotor must likewise be known in order to determine the next commutation point in time. This can occur via three different means. By way of example, a comparison with a neutral point displacement voltage can occur, the EMF can be measured directly, or a comparison with the half supply voltage can occur. Comparison measurements are carried out, for example, with three existing phases, in which two phases are supplied with current, a positive and a negative current, and the third phase remains currentless. The counter EMF in the currentless phase has a zero crossing at the intersection as a result of the positive and negative supply voltage. The zero crossing is in the middle, between two commutations. Thus, the zero crossing, and thus the point in time at which the commutation is to take place, can be determined. This is the case when the currentless phase crosses the half zero voltage. At the same time, the rotational rate can also be determined, because it is dependent on the voltage. By way of example, the size of the EMF is proportional to the angular speed of the rotor for a given motor having a fixed magnetic flux and fixed number of windings.

For practical purposes, with known BLDC controls based on detecting the zero crossing of the induced voltage in an inactivated phase is measured with the granularity of the PWM (PWM: pulse width modulation), or the doubled PWM frequency of the induced voltage, and compared with half of the supply voltage, or the zero voltage. When this event is detected, the next commutation point in time is determined using the likewise detected current rotational rate. For this, it is tested or sampled, once or twice, whether the next commutation state is to be set in each PWM period. The current rotational rate is determined with the granularity of the PWM, or the doubled PWM frequency. For this, the number of PWM periods between two commutation points in time is referenced. The PWM can be configured symmetrically or asymmetrically, i.e. aligned with the center or the edge.

The determination of the zero crossing occurs, e.g. by means or one or more comparators and a timer. Thus, the time that passes from the start of a state until crossing both voltages, thus the zero crossing, can be determined. This same time passes until the next commutation. When one of the two supply voltages for the phases is zero, or grounded, the zero crossing voltage is one half of the motor supply voltage. The timer is reset after each commutation, and the next commutation point in time is recalculated at the next detected zero crossing.

In order to determine the commutation point in time, only a multiple of the PWM period can be used in known methods. This means that, as a result of the determination of the commutation point in time with the granularity of the PWM or doubled PWM frequency, the machine may not be commutated at the right point in time with respect to the induced voltage or the flux. This erroneous commutation may result in noises and unintended current shapes in the AC/DC current. Furthermore, the determination of the current rotational rate, caused by the granularity of the detection described above, is erroneous. Moreover, there are limitations to the maximum rotational rate in the base speed range, and a limitation in terms of the possibility for field weakening in the preliminary commutation.

Therefore, it is an object of the invention to provide a method for sensorless BLDC commutation, as well as an appropriate controller, by means of which the problems specified above are overcome.

This objective is achieved in accordance with the disclosure below.

### SUMMARY

In accordance with this disclosure, a method is proposed for sensorless BLDC commutation, comprising the following steps. In step 1, the voltage of a currentless phase is sampled in predetermined time intervals. In step 2, the voltage of the zero crossing, and the associated rotational rate, is determined on the basis of the time difference between two sampling points, and the point in time of the zero crossing is supplied to a commutation timer K, when a zero crossing has been detected between two sampling points. In step 3, the time until a predefined angular rotation of the motor is calculated on the basis of the determined rotational rate, and this time is transmitted to the commutation timer. In step 4, the commutation is initiated and the commutation time is reset when the time transmitted to the commutation time has elapsed.

By means of this method, a much more precise determination of the point in time for the next commutation is obtained, because only multiples of the PWM period no longer have to be calculated, but rather, a precise time for a zero crossing can be determined. Based thereon, because the precise point in time when the next commutation must take place can be calculated based on the rotational rate determined at this point in time.

In one design, the time difference between two sampling points is determined in step 2, in that a line is drawn through two sampling points.

By drawing a line, the zero crossing can be determined in a simple manner based on the time elapsed between the two sampling points.

In another design, the time difference between the two sampling points is determined in step 2 though linear or exponential interpolation. In another design, the time difference between two sampling points is determined in step 2, in that additional sampling points prior to and subsequent to the first and second sampling points are referenced for the determination, and evaluated by means of complex interpolation methods.

Through interpolation, more precise values for the zero crossing, and thus the commutation point in time, can be determined. The selection of the methods depends thereby on how much computing power and which hardware are available, and what precision is required by the corresponding application.

In another design, an interruption is also inserted at the point in time of the commutation in step 4, when the time transmitted to the commutation time has elapsed. An interruption serves to ensure an automated execution of the commutation. The interruption indicates that the time until the next commutation has elapsed, and the commutation time can be reset after, or in the event of, a resulting commutation.

Furthermore, a controller is provided, which is configured to execute the methods provided in this disclosure.

Further features and advantages of this disclosure can be derived from the following description of exemplary embodiments, based on the figures in the drawings, which show details in accordance with this disclosure, and from the claims. Each of the individual features can be realized in and of themselves, or in arbitrary combinations in variations of this disclosure.

### BRIEF DESCRIPTION OF THE DRAWINGS

Preferred embodiments of this disclosure shall be explained in greater detail below, based on the drawings.

FIG. 1 shows a section of an event diagram for determining the zero crossing in accordance with one design of this disclosure.

FIG. 2 shows a flow chart of the method in accordance with one design of this disclosure.

### DETAILED DESCRIPTION OF EXAMPLE EMBODIMENTS

Identical elements or functions are provided with the same reference symbols in the following description of the figures.

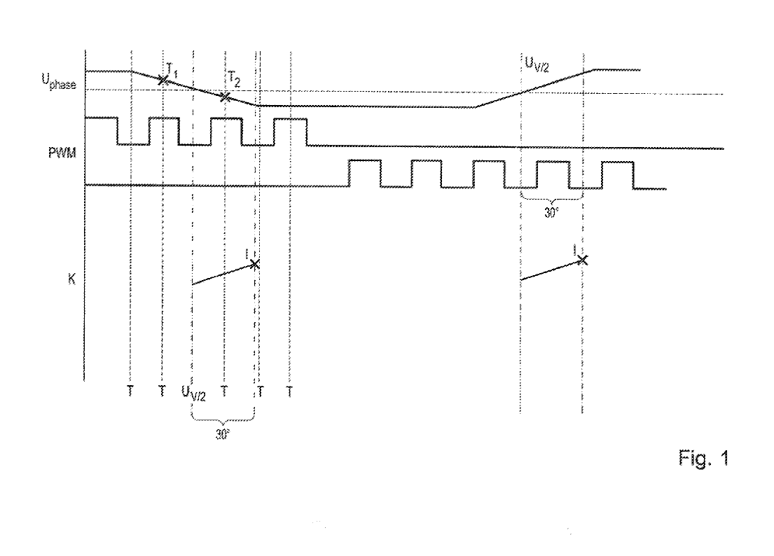

FIG. 1 shows a section of an event diagram for determining the zero crossing in accordance with one design of this disclosure.

The fundamental determination of the position data of a rotor can be obtained through the evaluation of the direction reversal of the induced voltage in the respective currentless or powerless motor coil. For this reason, the induced voltage is referred to as the zero voltage. The switching of the voltage at another motor phase is referred to as commutation.

The needed stator rotary field can be applied to the motor, e.g. through square wave signals at two of three motor phases. The signals can be pulse width modulated signals (PWM signals), in order to optimize the switching slopes. The number of magnetic poles of the rotor is irrelevant, because multi-polar systems can be mapped fundamentally onto bipolar systems.

In order to determine the next commutation, the zero crossing is detected in the prior art through sampling, and, e.g., 30° motor rotation must subsequently be commutated. For the next commutation point in time, the number of PWM cycles until the next zero crossing are determined therefrom, and when the next zero crossing has been reached, a positive 30° motor rotation is again commutated. This method counts PWM cycles, and thus can only commutate in multiples of PWM cycles.

These fundamentals are known to the person skilled in the art, and shall not be explained herein in greater detail.

In the solution according to this disclosure, as in the prior art, the voltage of the currentless phase Uₚₕₐₛₑ is sampled at least twice in each commutation period. This is shown by the broken perpendicular lines T in FIG. 1. If it is detected in the sampling procedure that a zero crossing U_{v/2} has occurred, i.e. the sign of the first sampling point T₁ differs from the sign of the second sampling point T₂, this zero crossing U_{v/2} is determined from the difference of the value of the second sampling point T₂ to the value of the first sampling point T₁, or the respective associated time values derived therefrom. In doing so, a line between the first sampling value T₁ and the second sampling value T₂ is assumed. The point in time of the zero crossing U_{v/2} is transmitted to a commutation timer. The next commutation occurs following a further 30° of motor rotation. This time from the zero crossing to the 30° motor rotation is then determined on the basis of the current voltage-dependent rotational rate using known methods, and transmitted to the commutation timer K, such that it can initiate the commutation when the transmitted time has been reached. For this, a so-called interruption I is preferably inserted, through which the commutation point in time is indicated, and can be initiated accordingly. After the commutation with the commutation timer reset, and the next zero crossing and commutation point in time are determined with the same method.

The method of this disclosure used for determining the zero crossing is sufficient for most applications, because a very precise statement regarding the point in time of the zero crossing can be obtained herewith. If, however, a more precise point in time for the zero crossing should be necessary for applications, the sampling points after detection of a zero crossing can be linearly or exponentially interpolated in order to improve the detection of the precise value of the zero crossing. In order to make this detection even more precise, further sampling points prior to and subsequent to the detected zero crossing can be drawn on, and evaluated by means of more complex interpolation methods. The method selected for calculating the zero crossing depends on the respective application, the necessary precision, the available computing resources, and the available hardware thereby, and can be selected accordingly by a person skilled in the art.

The commutation timer used in accordance with this disclosure can likewise be used for determining the rotational rate, and therefore, an additional timer is not necessary. The temporal values of at least to successive commutation steps are drawn on for determining the rotational rate. Conversely, the time from the zero crossing until 30° motor rotation can be determined accordingly by determining the rotational rate.

Through the precise determination of the commutation point in time, independently of the multiples of the PWM period, the point in time of the commutation can be determined precisely, and thus the acoustic behavior, as well as the current ripple factor, can be improved.

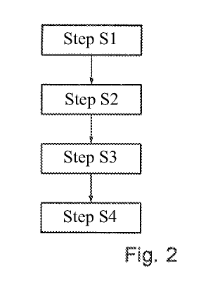

FIG. 2 shows a flow chart of the method, based on the event diagram described in FIG. 1, in accordance with one design of this disclosure. The voltage Uₚₕₐₛₑ of a currentless phase of a motor is sampled in predetermined time intervals in step S1. In step S2, the voltage U_{v/2} of the zero crossing, and the associated rotational rate, is determined on the basis of the time difference between two sampling points T₁, T₂, and the point in time of the zero crossing is transmitted to a commutation timer K, when a zero crossing has been detected between the two sampling points T₁, T₂. In step 3, the time until a predetermined angular rotation of the motor is calculated on the basis of the determined rotational rate, and this time is transmitted to the commutation timer K. In step 4, the commutation is initiated, and the commutation timer K is reset, when the time transmitted to the commutation timer K has elapsed.

The method according to this disclosure offers the advantage that the zero crossing, thus the point in time, based on which the commutation point in time is calculated, can no longer only be determined in multiples of the PWM periods or frequencies. Instead, due to the calculation of the zero crossing based on the time difference between two sampling points, within which the zero crossing occurs, and setting a corresponding timer, the commutation timer, the zero crossing, and thus the next commutation point in time, can be calculated precisely. The precision depends thereby on selected calculation methods, and can be selected accordingly, depending on the application.

It is assumed in the explanations above, that a commutation is to occur after 30° of motor rotation. This is merely regarded as an illustrative example, and can be used for other needed angular rotations of the motor accordingly, because the commutation timer is time controlled, and only the time needed until the commutation need be transmitted.

### LIST OF REFERENCE SYMBOLS

K Commutation time

Uphase Voltage of the currentless phase

UV/2 Zero crossing at half of the supply voltage

PWM Pulse width modulated voltage

T Sampling point in time

T1 First sampling point in time

T2 Second sampling point in time

I Interruption

1. A method for sensorless commutation of a brushless direct current motor, the method comprising:
sampling a voltage of a currentless phase in at least two predetermined time intervals.
determining the voltage of a zero crossing point and determining an associated rotational rate on the basis of a time difference between the at least two sampling points and transmitting a point in time of the zero crossing point to a commutation timer, when the zero crossing has been detected between the at least two sampling points,
calculating a time until a predetermined rotation of the motor on the basis of the determined rotational rate, and transmitting the time until a predetermined rotation of the motor to the commutation timer,
initiating a commutation and resetting the commutation timer when the time until a predetermined rotation of the motor transmitted to the commutation timer has elapsed.

2. The method according to claim 1, wherein the time difference between the at least two sampling points is determined by a line drawn between the at least two sampling points.

3. The method according to claim 1, wherein the time difference between the at least two sampling points is determined through interpolation.

4. The method according to claim 1, wherein additional sampling points prior to and subsequent to the first and second sampling points are used for determining the zero crossing point.

5. The method according to claim 1, wherein an interruption is initiated at the point in time of the commutation, when the time until a predetermined rotation of the motor transmitted to the commutation timer (K) has elapsed.

6. A system for controlling commutation of a brushless direct current motor, the system comprising:
a commutation timer, and
a controller configured to:
sample a voltage of a currentless phase in at least two predetermined time intervals,
determine the voltage of a zero crossing point and determine an associated rotational rate on the basis of a time difference between the at least two sampling points and transmit a point in time of the zero crossing point to a commutation timer, when the zero crossing has been detected between the at least two sampling points,
calculate a time until a predetermined rotation of the motor on the basis of the determined rotational rate, and transmit the time until a predetermined rotation of the motor to the commutation timer,
initiate a commutation and reset the commutation timer when the time until a predetermined rotation of the motor transmitted to the commutation timer has elapsed.

7. The method according to claim 3, wherein the time difference between the at least two sampling points is determined through linear interpolation.

8. The method according to claim 3, wherein the time difference between the at least two sampling points is determined through exponential interpolation.

9. The method according to claim 1, wherein a timer in addition to the commutation time is not used to commutate the motor.

10. The method according to claim 1, wherein the zero crossing voltage is determined from the difference between the value of the second sampling point voltage and the value of the first sampling point voltage.

11. The method according to claim 1, wherein the zero crossing voltage is determined based on the difference between the time value of the second sampling point and the time value of the first sampling point.

12. The method according to claim 5, wherein the interruption initiates an automated execution of the commutation.

13. The system according to claim 6, wherein the time difference between the at least two sampling points is determined by a line drawn between the at least two sampling points.

14. The system according to claim 6, wherein the time difference between the at least two sampling points is determined through interpolation.

15. The system according to claim 6, wherein the controller is configured to sample additional sampling points prior to and subsequent to the first and second sampling points, wherein the additional sampling points are used for determining the zero crossing point.

16. The system according to claim 6, wherein the controller is configured to initiate an interruption at the point in time of the commutation, when the time until a predetermined rotation of the motor transmitted to the commutation timer has elapsed.

17. The system according to claim 16, wherein the interruption initiates an automated execution of the commutation.
